(19) United States
(12) Patent Application Publication
(10) Pub. No.: US 2014/0000138 A1
(43) Pub. Date: Jan. 2, 2014

(54) Composite Magnetic Tag

(71) Applicant: Ellen Cable, Madison, NJ (US)

(72) Inventor: Ellen Cable, Madison, NJ (US)

(21) Appl. No.: 13/947,030

(22) Filed: Jul. 20, 2013

Related U.S. Application Data
(63) Continuation-in-part of application No. 13/534,176, filed on Jun. 27, 2012, now Pat. No. 8,510,977.

(51) Int. Cl. G09F 3/04

(52) U.S. Cl. CPC G09F 3/04
USPC 40/661.01

(57) ABSTRACT

A tripartite composite magnetic tag comprises a central plate, containing a magnetic material, sandwiched between two magnetic outer panels, which bear graphic and/or alphanumeric indicia. The composite magnetic tag is attachable by one or more connective means to various personal items through one or more composite apertures. The magnetic outer panels are interchangeable with replacement panels bearing different indicia, such that the composite magnetic tag can serve multiple identification and/or decorative purposes. Optionally, the central plate can also bear graphic and/or alphanumeric indicia, which can be viewable through openings in either or both of the magnetic outer panels.

### REFERENCE TO RELATED APPLICATION

This application is a continuation-in-part of U.S. patent application Ser. No. 13/534,176, filed on Jun. 27, 2012.

### BACKGROUND OF THE INVENTION

The present invention relates to the field of tags that are attachable for identification and/or decorative purposes to personal items, such as key chains, backpacks, laptop computers, cell phones, briefcases, luggage or articles of clothing. More specifically, the present invention relates to such tags wherein the identification and/or decorative elements are replaceable and/or interchangeable magnetic panels.

The use of attachable tags to identify the owner of personal items and/or to enhance their appearance is widespread and growing with the proliferation of portable electronic devices. Such tags have also increasingly become items of personal style, through which the owner can display his/her interests in sports, music and other aspects of popular culture. For example, a high school athlete might want to have a tag depicting lacrosse sticks attached to his/her sports bag when he/she is participating in a lacrosse match. But the same athlete might want to have his/her bag tag display a basketball when he/she is participating in that sport. It would therefore be advantageous to have a tag in which the identification/decorative elements are interchangeable, so that a single tag could serve multiple purposes and display multiple interests of the owner.

The present invention provides a tag with a composite structure comprising two indicia-bearing magnetic panels, which are removably attachable to a central plate containing a magnetic material. In use, the central plate is retained, while the outer panels can be interchanged to alter the outward appearance of the tag as desired.

### SUMMARY OF THE INVENTION

The present invention is a tripartite composite magnetic tag, comprising two substantially congruent magnetic outer panels and a substantially congruent central plate containing a magnetic material. The magnetic outer panels can comprise either a single magnetic layer or a composite of a magnetic interior layer bonded to or coated by a non-magnetic exterior layer. The central plate is a plate which substantially conforms to the size and shape of the two magnetic outer panels. The central plate can be made of one or more ferromagnetic materials, such as stainless steel, or can be a composite comprising a non-ferromagnetic core that is coated, encased or surrounded by one or more ferromagnetic materials.

Each of the two magnetic outer panels attaches by its magnetic layer to either face of the central plate, thereby forming a composite “sandwich” tag, in which the exterior sides of the magnetic outer panels are visible. Each of the two magnetic outer panels can have one or more apertures, each of which aligns cooperatively with corresponding apertures of the other magnetic outer panel and of the central plate to form a composite aperture, such that the assembled composite tag can be attached to one or more other items by a connective means, such as a cord, ring, chain or clip, inserted through one or more of the composite apertures.

Either or both of the magnetic outer panels and/or the central panel can contain graphic and/or alphanumeric indicia, including but not limited to: photographs, pictures, artwork, text, calligraphy, or visually encoded data, such as barcodes or QR codes. Such indicia are incorporated through one or more methods, including but not limited to printing, engraving, laser marking, etching, offset printing, dye sublimation, heat transfer, painting, imprinting, stamping, manual or pre-applied adhesive, marker, handwriting, injection molding, labeling, foil stamping, 3D printing or holographic printing. The incorporated indicia can be used to convey information, including but not limited to the following: (a) contact information about an individual or organization, such as a name and/or address; (b) a message; (c) a quotation, poetry or literary passage; (d) one or more identifiers which represent an individual, such as a customer number; (e) an internet address, email address, phone number or other identifier, locator or contact method for a person, organization, or web page; (f) medical information, such as a list of allergies or medical history; or (g) information regarding a pet, such as a dog's owner's information.

The tripartite composite magnetic tag of the present invention can function as an identification device for bags or luggage, pets, or items, as a keychain, as a conveyance for medical information in textual form, as a conveyance for visually-encoded data, such as QR codes or barcodes, which represent data stored elsewhere, or as a customizable item, in which the central plate and magnetic outer panels are customized with photos, images, or text.

The composite magnetic tag can have any one of a variety of shapes and contours, including but not limited to basic geometric shapes, such as a circle, square, triangle, rhombus or heart; or complex shapes, such as an apple, dog, or tree or person. Optionally, either or both of the magnetic outer panels can contain a “window” opening through which central plate can be viewed.

The foregoing summarizes the general design features of the present invention. In the following sections, a specific embodiment of the present invention will be described in some detail. This specific embodiment is intended to demonstrate the feasibility of implementing the present invention in accordance with the general design features discussed above. Therefore, the detailed description of this embodiment is offered for illustrative and exemplary purposes only, and it is not intended to limit the scope either of the foregoing summary description or of the claims which follow.

### BRIEF DESCRIPTION OF THE DRAWINGS

FIG. 1A is a plan view of the exterior side of one of the magnetic outer panels of a composite magnetic tag according to the preferred embodiment of the present invention;

FIG. 1B is a plan view of the interior side of one of the magnetic outer panels of a composite magnetic tag according to the preferred embodiment of the present invention;

FIG. 1C is a plan view of the ferromagnetic central plate of a composite magnetic tag according to the preferred embodiment of the present invention;

FIG. 2 is an exploded view of a composite magnetic tag according to the preferred embodiment of the present invention;

FIG. 3 is a perspective view of a composite magnetic tag according to the preferred embodiment of the present invention, illustrating the connection of the tag to a standard key ring;

FIG. 4 is a plan view of the ferromagnetic plate containing identity information; and

FIG. 5 is an exploded view of a composite magnetic tag in which both of the magnetic outer panels have an opening through which the central plate can be viewed.

### DETAILED DESCRIPTION OF THE PREFERRED EMBODIMENT

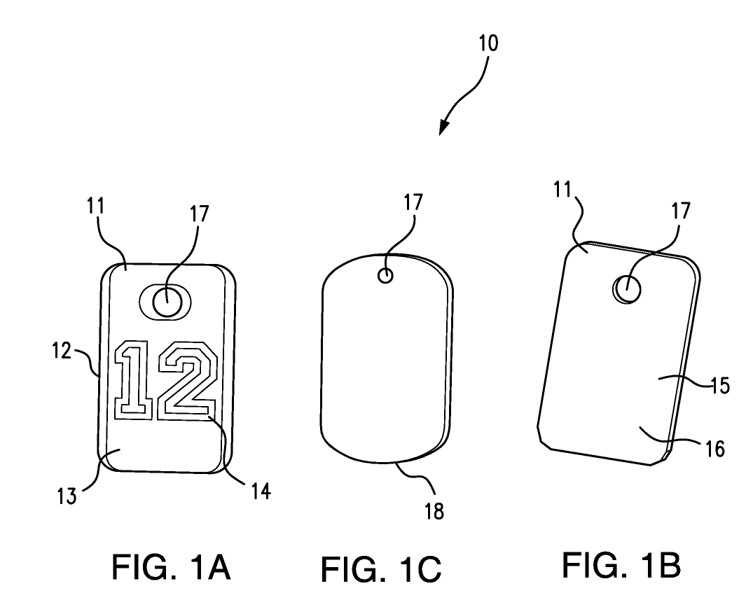

Referring to FIGS. 1A, 1B and 1C, the magnetic outer panels 11 of the composite tag 10 are rectangular with rounded corners, preferably with a long-side length of 1.5 to 2.5 inches and short-side width of 0.75 to 1.25 inches. The exterior side 12 of each outer panel 11 has a concave “domed” resin plastic surface 13 bearing graphic and/or alphanumeric indicia 14. The interior side 15 of each outer panel 11 comprises a magnetic surface 16.

The upper portion of each outer panel 11 has a circular aperture 17, which aligns cooperatively with corresponding apertures 17 in the other outer panel 11 and the ferromagnetic central plate 18. As shown in FIG. 1C, the ferromagnetic central plate 18 substantially conforms to the shape and dimensions of the outer panels 11, and is preferably made of a thin gauge stainless steel.

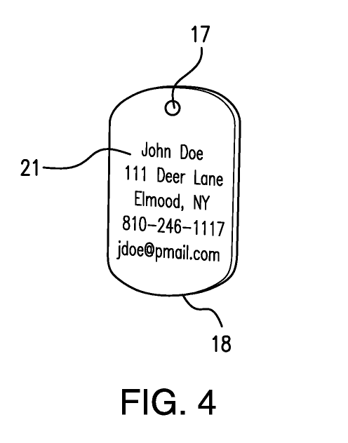

Optionally, as depicted in FIG. 4, the ferromagnetic central plate 18 can contain identity information 21 regarding the owner of the tagged item, such as name, address, phone and/or e-mail. In this alternative, the outer panels 11 would also serve to conceal the incorporated identity information from public view.

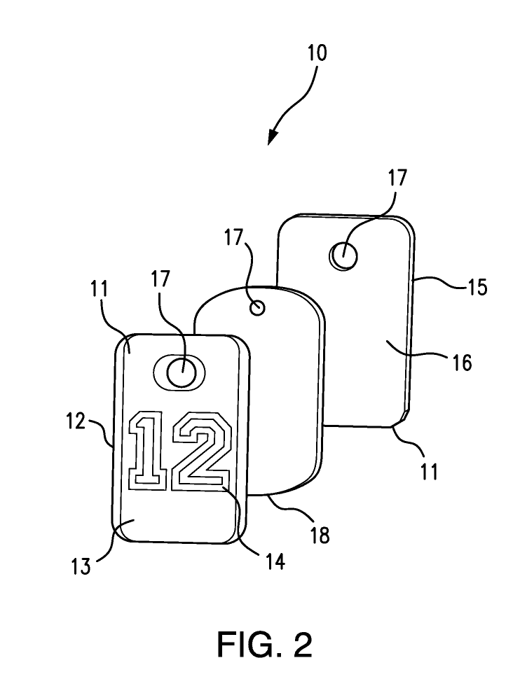

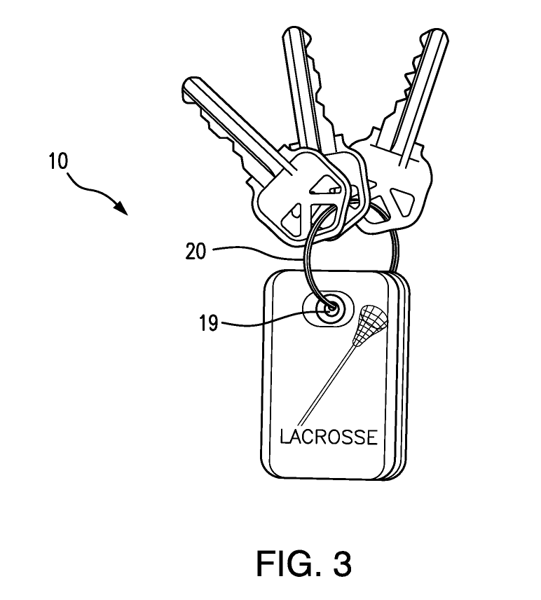

As depicted in FIGS. 2 and 3, the composite magnetic tag 10 is assembled by attaching the magnetic surface 16 of the interior side 15 of each outer panel 11 to one of the faces of the ferromagnetic central plate 18, such that the circular apertures 17 align with one another to form a composite aperture 19. As illustrated in FIG. 3, the assembled composite tag can be attached to one or more items by a connective means 20—in this case a key ring—inserted through the composite aperture.

As illustrated in FIGS. 2 and 3, the assembled composite tag 10 displays the indicia 14 on the exterior sides 12 of the two outer panels 11. Accordingly, these indicia 14 can be changed by magnetically attaching different outer panels 11 to the ferromagnetic central plate 18. In this way, the composite tag 10 structure can be used for a wide variety of identification and/or decorative functions.

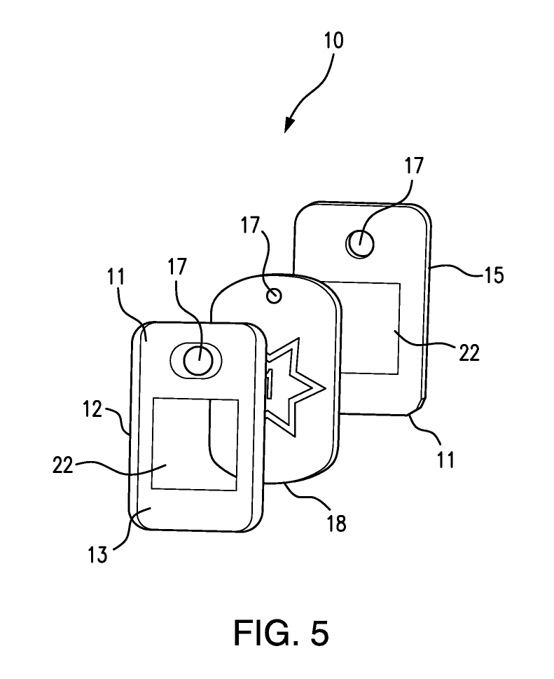

Optionally, as depicted in FIG. 5, either or both of the magnetic outer panels can have an opening 22, through which the central plate 18 and any indicia contained thereon can be viewed.

While the outer panels 11 and central plate 18 have been depicted with rounded rectangular shapes, it should be understood that they can be configured to have any shape, including various geometrical shapes, as well as shapes representing the outline of an object, a symbol, a plant, an animal, a person, etc.

Although the preferred embodiment of the present invention has been disclosed for illustrative purposes, those skilled in the art will appreciate that many additions, modifications and substitutions are possible, without departing from the scope and spirit of the present invention as defined by the accompanying claims.

What is claimed is:

1. A composite magnetic tag, comprising:
two magnetic outer panels, consisting of a first outer panel and a second outer panel;
a central plate containing a magnetic material;
wherein each of the magnetic outer panels has a magnetic interior side and a non-magnetic exterior side, which contains one or more indicia in the form of graphic designs, visually-encoded data, photographs and/or alphanumeric characters;
wherein the central plate substantially conforms to the size and shape of the two magnetic outer panels; and
wherein each of the two magnetic outer panels attaches by its magnetic interior side to either face of the central plate, thereby assembling a composite tag, in which the central plate is sandwiched between the two magnetic outer panels, such that the indicia on the exterior sides of the magnetic outer panels are visible.

2. The composite tag of claim 1, wherein the first outer panel has one or more circular aperture(s), each of which aligns cooperatively with a corresponding aperture of the second outer panel and a corresponding aperture of the central plate, such that one or more composite aperture(s) is/are formed when the composite tag is assembled, and such that the assembled composite tag can be attached to one or more items by one or more connective means inserted through the composite aperture(s).

3. The composite magnetic tag of claim 2, wherein the magnetic outer panels are interchangeable with one or more replacement panels having the same form and structure as the magnetic outer panels but containing alternate indicia that differ from the indicia of the magnetic outer panels.

4. The composite magnetic tag of claim 3, wherein the central plate contains one or more indicia in the form of graphic designs, visually-encoded data, photographs and/or alphanumeric characters.

5. The composite magnetic tag of claim 4, wherein either or both of the magnetic outer panels contain an opening through which the central plate can be viewed.

6. A composite magnetic tag, comprising:
two magnetic outer panels, consisting of a first outer panel and a second outer panel;
a central plate containing a magnetic material;
wherein each of the magnetic outer panels contains one or more indicia in the form of graphic designs, visually-encoded data, photographs and/or alphanumeric characters;
wherein the central plate substantially conforms to the size and shape of the two magnetic outer panels; and
wherein each of the two magnetic outer panels attaches to either face of the central plate, thereby assembling a composite tag, in which the central plate is sandwiched between the two magnetic outer panels, such that the indicia on the magnetic outer panels are visible.

7. The composite tag of claim 6, wherein the first outer panel has one or more circular aperture(s), each of which aligns cooperatively with a corresponding aperture of the second outer panel and a corresponding aperture of the central plate, such that one or more composite aperture(s) is/are formed when the composite tag is assembled, and such that the assembled composite tag can be attached to one or more items by one or more connective means inserted through the composite aperture(s).

8. The composite magnetic tag of claim 7, wherein the magnetic outer panels are interchangeable with one or more replacement panels having the same form and structure as the magnetic outer panels but containing alternate indicia that differ from the indicia of the magnetic outer panels.

9. The composite magnetic tag of claim 8, wherein the central plate contains one or more indicia in the form of graphic designs, visually-encoded data, photographs and/or alphanumeric characters.

10. The composite magnetic tag of claim 9, wherein either or both of the magnetic outer panels contain an opening through which the central plate can be viewed.
